(19) United States
(12) Patent Application Publication
(10) Pub. No.: US 2006/0261980 A1
(43) Pub. Date: Nov. 23, 2006

(54) Device and utilisation method for determining user charges for travelling on stretch of road

(75) Inventor: Wolfgang Beier, Weilder Stadt (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 10/548,871

(22) PCT Filed: Jan. 24, 2004
(86) PCT No.: PCT/EP04/00588

§ 371 Date: May 12, 2006

(30) Foreign Application Priority Data
Mar. 14, 2003 (DE) 103 11 653.2

(51) Int. Cl. G08G 1/123

(52) U.S. Cl. 340/988; 340/928

(57) ABSTRACT

A method of using a road toll determination apparatus in a vehicle to generate and transmit to oncoming vehicles information about the road ahead. Such apparatus comprises a digital map of a road network, sensors for data collection, a short-range communication device and a processor. Road section curve-related data are generated from the sensor data, and the short-range communication device is used for sending or receiving road-section curve-related data to and from an approaching vehicle.

This application claims the priority of German patent document 103 11 653.2, filed Mar. 14, 2003 (PCT International Application No. PCT/EP2004/000588, filed Jan. 24, 2004), the disclosure of which is expressly incorporated by reference herein.

### BACKGROUND AND SUMMARY OF THE INVENTION

The invention relates to a method for using components of an apparatus for determining vehicle road tolls to generate and transmit safety related information regarding curves in a section of road that has been traversed.

An apparatus for determining vehicle tolls is described, for example, in German patent document DE 43 04 838 C2, the disclosure of which is incorporated herein by way of reference. To determine the toll, the apparatus in the vehicle includes a digital map of a road network, for example, in the form of a CD or DVD, which is used to ascertain the toll for the road network in the vehicle. There are also sensors for data collection, such as a position-finding means in the form of a GPS or Galileo satellite navigation system, and a processor which checks and calculates the toll. In addition, an apparatus operated in this manner involves the use of a short-range communication means (e.g., in the infrared domain) to control the operation of the apparatus at selected locations.

It is an object of the invention to provide a method that uses a vehicle's apparatus for determining vehicle tolls in a more universal manner.

Another object of the invention is to provide a method which uses such road toll determining apparatus to generate and transmit to oncoming vehicles information about the road ahead.

These and other objects and advantages are achieved by the method according to the invention, in which existing toll determining apparatus is used for generating road-section curve-related data from the sensor data, and a short-range communication device can be used to send and/or receive road-section curve-related data. In other words, road-section curve-related data are generated from the sensor data and can be sent to at least one approaching vehicle using the short-range communication device. The approaching vehicle can also use the short-range communication device to output information in the vehicle.

According to the invention, the vehicle's apparatus for determining tolls—hereinafter called ETC (Electronic Toll Collection) apparatus—is used to transmit road-section curve-related data (hereinafter called “curve data”). In this case, the transmission is made between vehicles which are equipped with an ETC apparatus. The curve data are generated by a first vehicle from sensor data generated by its ETC apparatus, and are sent to a second, approaching vehicle using the short-range communication device in the ETC apparatus. The second vehicle receives the curve data using the short-range communication device in this ETC apparatus and uses these data to output information if appropriate, e.g., using the output means in the ETC apparatus.

Thus, the short-range communication device in the ETC apparatus is used for purposes other than originally intended, to transmit curve data from a first, vehicle which has just encountered a curve, to a second, approaching vehicle (which will thus soon enter the curve). The ETC apparatus includes all of the components required for such transmission between a multiplicity of vehicles; all such components therefore are present on board the vehicle. Similarly, the ETC apparatus includes the further components required by the inventive apparatus. Besides the short-range communication device, these include sensors for data collection, the processor and the digital map. The sensors and/or the digital map are used to ascertain curve data (e.g., the length and curvature of the curve), in the vehicle on an up-to-date basis. The processor controls the ascertainment and sending or receiving and the processing of the curve data. In addition, the processor may provide the means for generating the curve data from the sensor data (e.g., in the form of an appropriately designed circuit). To operate the ETC apparatus, output means are provided such as an alphanumeric display or a buzzer, which can be used according to the invention.

The inventive method thus provides a curve warning system which, together with the determination of tolls, may be implemented by the ETC apparatus. In particular, no additional, costly means are required in the vehicle for implementing the curve warning system, and corresponding installation costs are eliminated. Such means are needed for conventional curve warning apparatuses, such as a navigation appliance. This also has the associated problem of the database in the case of conventional curve warning apparatuses. Conventional apparatus requires a complete data base (e.g., in the form of a CD or DVD), which must be updated continuously. This problem naturally does not arise when data are generated in accordance with the invention, generation is always up-to-date.

The use of the ETC apparatus (which is already present on board the vehicle) for curve warning immediately achieves a high level of equipment and hence provides an effective transmission infrastructure. According to the invention, no additional equipment is required on board the vehicle; rather, already existing equipment is put to an additional use. The effective prevention of potential accidents by the invention in turn promotes the possible further spread of the ETC apparatus. In addition, the high level of equipment ensures that the curve data are transferred quickly, which increases accuracy even further. The only changes required for the use of the ETC apparatus in this manner are the control commands that are to be executed in the processor of the ETC apparatus. This makes the ETC apparatus more universally usable, and means that it becomes more cost effective.

It is possible to equip the vehicles in different ways within the meaning of the invention. For example, only some of the vehicles with an ETC apparatus may generate the curve data from the sensor data and send them using the short-range communication device. Similarly, it is not necessary for every vehicle with an ETC apparatus to receive curve data using the short-range communication device and to output information using these curve data.

A particular advantage is achieved when the invention is introduced on commercial vehicles. Not only are commercial vehicles in transit particularly frequently, and for long periods of time, but they also have the potential to cause the worst accidents, such as when dangerous goods are being transported. This immediately reveals the acute economic advantages of the invention. This is because when a vehicle equipped according to the invention approaches a curve and is provided with curve data by an approaching vehicle (which is likewise equipped according to the invention), there is less likelihood of a curve being underestimated by the driver. This results in a significant increase in safety, particularly for vehicle drivers who are not familiar with the area.

One advantageous embodiment of the invention additionally comprises a rotation rate sensor, which ensures especially simple and accurate determination of curvatures.

Advantageously, a data link is provided between the ETC apparatus and sensors and/or control units on the vehicle. By taking into account odometer signals, for example, the accuracy of curve data is improved further. Such a data link is ordinarily provided by the ETC apparatus, for example using a vehicle-based data network (CAN, “Controlled Area Network”), simply to determine tolls. Hence, no additional costs arise here. In addition, as part of the curve data, for example, it is possible to transmit that the windshield washer function has been activated, and thus that less adhesion to the road can be expected on account of rain. Another example is the use of data from traction and/or antilock systems for directly measuring the nature of the road in the curve.

In one particularly compact embodiment of the invention, the means for generating curve data is in the form of part of the processor.

In an advantageous embodiment, the short-range communication device is operated in the infrared domain, thus providing a simple and robust transmission channel which has already been implemented for control requests associated with the determination of tolls by the ETC apparatus, and is just as suitable for the inventive use.

The invention becomes particularly universally usable because curve data are also generated for sections of road which are not covered by a digital map of the road network. This permits use of the invention on arbitrary sections of road, with the curve data being generated using the vehicle's sensors for data collection.

So as not to burden the inventive system unnecessarily and to ensure a high level of data quality, it is proposed that following the generation of curve data, the processor perform a check to determine whether the curve data need to be sent. If, for example, there is a data link between the ETC apparatus and sensors on the vehicle such that it can be determined that a turn indicator light is activated while a sharp is being measured, it can be inferred that the vehicle is turning off. Since an approaching vehicle itself does not need to turn off, there is no need to send data in this case.

So as not to overload the vehicle driver with information outputs from the curve warning system according to the invention, it is provided that following the reception of curve data the processor can perform a check to determine whether these data need to be used for outputting information in the vehicle.

The invention becomes even more universally usable if external intervention can be used to perform an altered check to determine whether the curve data need to be sent or output in the vehicle. For such external intervention, an external computer unit can be used, for example, to perform the altered check. The external computer unit (e.g., a service center) can provide an improved checking algorithm, for example wirelessly using a mobile radio network. Another option would be to connect the external computer unit, such as a portable computer, using a diagnostic interface in the course of an ordinary visit to the workshop.

In one particularly preferred embodiment of the invention, the received curve data are used by the processor in the vehicle to determine a maximum speed for the vehicle, preferably also taking into account data characterizing individual vehicle features, such as weight, class, and type of load. Such data are stored in a nonvolatile memory in the processor, for example.

Preferably, the information is output in the vehicle only if its speed exceeds the maximum speed which has been determined, in which case it is possible that the driver had underestimated the curve ahead, so that it is appropriate to inform or warn him or her. For this purpose, the speed of the vehicle may be a current speed, an average speed or a speed extrapolated at the time of entry into the curve, for example.

The information which is output in the vehicle can be quickly detected by the vehicle driver if it includes the distance from the vehicle to the start of the curve in the section of road.

The output of information is particularly effective if it is performed by output and/or warning means provided in the vehicle, for example by the audio system or an external display.

In a further embodiment, a message can be stored and/or sent if the speed of the vehicle exceeds the maximum speed which has been determined. Such a message may, for example, be stored in a special, nonvolatile memory area of the processor (chip card), or sent to an external computer via mobile radio network. Thus, for example, the proprietor of the vehicle can be informed that a vehicle driver is driving in a particularly risky fashion.

Other objects, advantages and novel features of the present invention will become apparent from the following detailed description of the invention when considered in conjunction with the accompanying drawings.

### BRIEF DESCRIPTION OF THE DRAWINGS

FIG. 1 shows the action of the invention in schematic form; and

FIG. 2 is a schematic diagram of a toll determining apparatus of the type used to practice the method according to the invention.

### DETAILED DESCRIPTION OF THE DRAWINGS

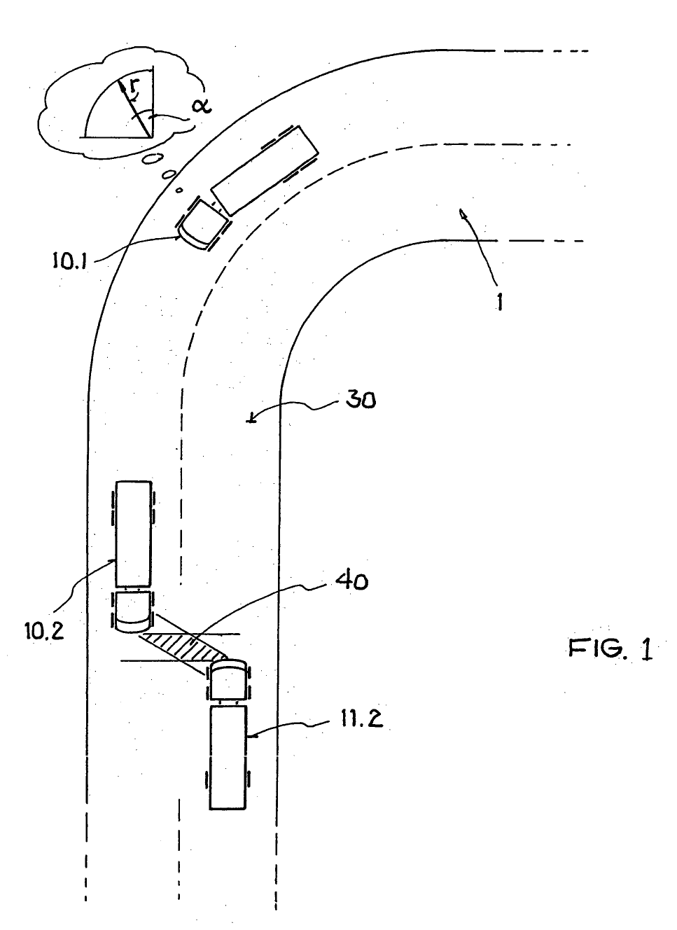

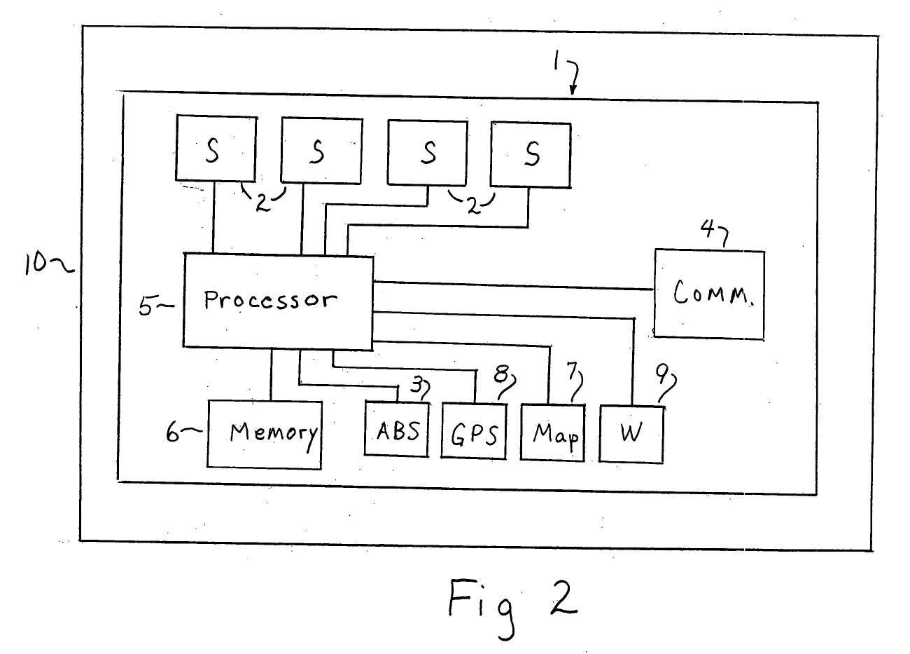

Referring to FIG. 1, two vehicles 10 and 11 are traveling in opposite directions on a section of road 1. At a time T1, the vehicle 10 is at the position 10.1, and at a time T2 (T2>T1) it is at the position 10.2. At a time T2, a vehicle 11 is also at the position 11.2. The vehicle 10 includes processor means 5 (FIG. 2) for generating curve data, using sensors 2 which are included in an apparatus for determining tolls in the vehicle 10. Such sensors may include, for example, a rotation rate sensor for determining the radius of curvature, a vehicle's odometer for determining the length of the curve and also traction and antilock systems 3 in the vehicle 10 for determining the nature of the road surface in the curve. As part of the curve data, the coordinates of the starting point of the curve, as shown for the vehicle 11, are also determined as the position 30. For this determination, a GPS receiver 8 is used as sensor. The apparatus for determining tolls also includes a digital map 7.

The vehicle 10 sends the curve data to the vehicle 11 using the short-range communication device in its apparatus for determining tolls. The vehicle 11 receives the curve data using the short-range communication device 4 in its apparatus for determining tolls. This communication takes place at the time T2, when vehicle 10 is at the position 10.2 and vehicle 11 is at the position 11.2. At that time, there is a communication zone 40 in which the curve data sent by the short-range communication device in vehicle 10 can be received by the short-range communication device in vehicle 11.

Using the curve data which have been received, the vehicle 11 determines a maximum safe speed for the curve starting at position 30. This determination is performed using stored data 6 which characterize features of vehicle 11, namely its weight, class and the type of load. Next, a check is performed to determine whether the speed of the vehicle 11 exceeds the maximum safe speed which has been determined, such that, it is possible that the driver has underestimated the curve ahead, which starts at position 30. Information or a warning 9 is therefore output to the vehicle driver. In addition, the distance to the start of the curve in the section of road is output (that is, the distance between the positions 11.2 and 30). The position 30 has been received by vehicle 11 as part of the curve data sent by vehicle 10, and the vehicle 11 determines its own position 11.2 by using a GPS receiver which is included in the apparatus for determining tolls in vehicle 11.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-19. (canceled)

20. Apparatus arranged in a vehicle for determining vehicle road tolls for traveling on a section of road, the apparatus comprising:
a digital map of a road network;
sensors for collecting sensor data;
a short-range communication device; and
a processor which is programmed for determining road tolls; wherein,
said apparatus also includes means for generating road-section curve-related data from the sensor data; and
the short-range communication device is adapted to send or receive road-section curve-related data.

21. The apparatus as claimed in claim 20, wherein a rotation rate sensor is additionally provided.

22. The apparatus as claimed in claim 21, wherein a data link between the apparatus and sensors or control units on the vehicle is also provided.

23. The apparatus as claimed in claim 22, wherein the means for generating road-section curve-related data is provided in the form of a processor, which is also programmed to determine such curve-related data.

24. The apparatus as claimed in claim 23, wherein the short-range communication device is operated in the infrared domain.

25. The apparatus as claimed in claim 24, wherein the vehicle is a commercial vehicle.

26. A method for operating a device mounted on a first vehicle for determining vehicle tolls for traveling a section of road, which device includes a digital map of a road network, sensors for collecting sensor data, a short-range communication device, and a data processor, said method comprising:
said processor using sensor data from said sensors to generate curve-related data for a section of road that has been traveled by said first vehicle;
using said short-range communication device to transmit said curve-related data to an oncoming vehicle, that approaches said section of road that has been traveled by said first vehicle.

27. The method according to claim 26, further comprising said second vehicle using said curve-related data to output information to an operator of said oncoming vehicle.

28. The method as claimed in claim 26, wherein said curve-related data include data generated for sections of road which are not covered by the digital map of the road network.

29. The method as claimed in claim 28, wherein following generation of the curve-related data the processor performs a check to determine whether these data need to be sent.

30. The method as claimed in claim 29, wherein following the reception of curve-related data a second processor in the oncoming vehicle performs a check to determine whether these data need to be used for outputting information in the vehicle.

31. The method as claimed in claim 30, wherein external intervention can be used to perform an altered check.

32. The method as claimed in claim 31, wherein the curve-related data received are used by the second processor to determine a maximum speed for the vehicle.

33. The method as claimed in claim 32, wherein data characterizing individual vehicle features are additionally used for determination of maximum speed.

34. The method as claimed in claim 33, wherein information is output to the vehicle operator only if actual speed of the oncoming vehicle exceeds the maximum speed which has been determined.

35. The method as claimed in claim 34, wherein the information which is output is a warning message.

36. The method as claimed in claim 35, wherein the information which is output further comprises distance from the oncoming vehicle to the start of a bend in the section of road.

37. The method as claimed in claim 36, wherein provision is made for a message to be stored and/or sent if the speed of the vehicle exceeds the maximum speed which has been determined.

38. In a device for determining vehicle tolls for traveling a section of road, which device includes sensors for collecting data used to determine said tolls, a short-range communication device and a data processor; a computer program product comprising a computer readable medium encoded with a program for causing said processor to perform the following steps:
using sensor data from said sensors to generate curve-related data for section of road traveled by said first vehicle;
using said short-range communication device to transmit said curve-related data to an approaching vehicle.

39. A method for generating and disseminating safety related road curvature information among vehicles having a toll calculating device for determining vehicle tolls for operating said vehicle on a section of road, said method comprising:
a processor contained in a first toll calculating device on board a first vehicle using sensor data generated by sensors contained in said first toll calculating device to generate road curvature information characterizing a particular section of road that have been traversed by said first vehicle; and
using a short-range communication unit contained in said first toll calculating device to transmit said road curvature information to a short-range communication unit contained in a second toll calculating device on board an oncoming second vehicle which is approaching said particular section of road.
